(19) United States
(12) Patent Application Publication
(10) Pub. No.: US 2026/0008594 A1
(43) Pub. Date: Jan. 8, 2026

(54) GUSSET BAGS WITH TEAR STRIPS

(71) Applicant: Illinois Tool Works Inc., Glenview, IL (US)

(72) Inventor: David J. Matthews, Gilman, IL (US)

(73) Assignee: Illinois Tool Works Inc., Glenview, IL (US)

(21) Appl. No.: 19/195,027

(22) Filed: Apr. 30, 2025

Related U.S. Application Data
(60) Provisional application No. 63/668,630, filed on Jul. 8, 2024.

(51) Int. Cl. B65D 30/20; B31B 70/26; B31B 70/81; B31B 155/00; B31B 160/20; B65D 33/25; B65D 75/58

(52) U.S. Cl. CPC B65D 31/10; B31B 70/266; B31B 70/81; B65D 33/2508; B65D 75/5844; B31B 2155/001; B31B 2160/20

(57) ABSTRACT

A gusset bag can include a front panel, a rear panel, and first and second gusset panels that extend around an interior volume. The front panel and the first gusset panel can be coupled with each other by a fin seal. A zipper assembly can be coupled with the front panel and at least a portion of the first gusset panel that is coupled with the front panel by the fin seal. The zipper assembly can include a tear strip having a head that can be grasped and pulled to pull the tear strip through at least the front panel to tear an opening through the front panel to provide access to the zipper assembly. The head of the tear strip can be disposed in the fin seal between the front panel and the first gusset panel.

### CROSS-REFERENCE TO RELATED APPLICATIONS

This application claims priority to U.S. Provisional Application No. 63/668,630 (filed 8 Jul. 2024), the entirety of which is incorporated by reference herein.

### BACKGROUND

### Technical Field

The subject matter described herein relates to gusset bags.

### Discussion of Art

Gusset bags include flexible packages having an additional panel of material between front and rear panels of the bags, or along opposite sides of the bags. These additional panels can be referred to as side gussets. Side gussets can provide additional volume inside the bags.

Tear strips may be included in other types of bags. Tear strips may be beneath a front panel of these other bags with a tab or head of the tear strip accessible via an opening through the front panel. These bags may be sealed around all four outer edges aside from this opening. A consumer can grasp this tab or head and pull the tear strip to form an opening through the front panel of the bag. The consumer can then access a zipper between the front panel and an opposite rear panel of the bag through this tear strip opening. The consumer can grasp opposite sides of the zipper and pull the sides away from each other to open the bag and reach contents inside the bag. The consumer can then press the sides of the zipper together to re-seal the bag.

Some known gusset bags may not have a tear strip due to the side gussets of the bag. The side gussets can make it difficult to provide an opening for a consumer to grasp the tear strip without cutting the opening through multiple sides of the gusset bags. A need may exist for a gusset bag having a tear strip.

### BRIEF DESCRIPTION

One example of a gusset bag described herein includes a front panel, a rear panel that is opposite the front panel, a first gusset panel that extends from the front panel to the rear panel, and a second gusset panel that is opposite the first gusset panel and that extends from the front panel to the rear panel. The front panel, the rear panel, the first gusset panel, and the second gusset panel can extend around an interior volume. The front panel and the first gusset panel can be coupled with each other by a fin seal. The gusset bag also can include a zipper assembly coupled with inside surfaces of the front panel and at least a portion of the first gusset panel that is coupled with the front panel by the fin seal. The zipper assembly can include interlocking elements that repeatedly mate and separate from each other to repeatedly seal and open the interior volume. The zipper assembly can include a tear strip having a head that can be grasped and pulled to pull the tear strip through at least the front panel to tear an opening through the front panel to provide access to the zipper assembly. The head of the tear strip can be disposed in the fin seal between the front panel and the first gusset panel.

One example of a method (e.g., for providing a gusset bag) described herein includes folding a web of material to form a front panel, a rear panel, a first gusset panel, and a second gusset panel, and placing a zipper assembly having interlocking bodies and a tear strip. The zipper assembly can be placed along the front panel and at least a portion of the first gusset panel. The interlocking bodies can repeatedly mate and separate from each other. The tear strip can have a head configured to be pulled to tear a hole through at least the front panel with the tear strip. The method also can include coupling the front panel with the at least the portion of the first gusset panel in a fin seal with the head of the tear strip positioned within the fin seal, directly or indirectly coupling top edges of the front panel, the rear panel, the first gusset panel, and the second gusset panel with each other, and directly or indirectly coupling bottom edges of the front panel, the rear panel, the first gusset panel, and the second gusset panel with each other to form a gusset bag having a tear strip behind at least the front panel.

Another example of a gusset bag described herein includes a front panel, a rear panel that is opposite the front panel, a first side panel that extends from the front panel to the rear panel, and a second side panel that is opposite the first side panel and that extends from the front panel to the rear panel. The front panel, the rear panel, the first side panel, and the second side panel can extend around an interior volume. The front panel and the first side panel can be coupled with each other by a fin seal with an access hole through at least the front panel. The gusset bag also can include a zipper assembly coupled with inside surfaces of the front panel and a portion of the first side panel that is in the fin seal. The zipper assembly can include interlocking elements that can repeatedly mate and separate from each other to repeatedly seal and open the interior volume. The zipper assembly can include a tear strip having a head disposed in the access hole and that can be grasped and pulled to pull the tear strip through at least the front panel to tear an opening through the front panel to provide access to the zipper assembly.

### BRIEF DESCRIPTION OF THE DRAWINGS

The inventive subject matter may be understood from reading the following description of non-limiting embodiments, with reference to the attached drawings, wherein below:

FIG. 1 illustrates one example of a gusset bag;

FIG. 2 illustrates a cross-sectional view of one example of a zipper assembly shown in FIG. 1;

FIG. 3 illustrates another example of a gusset bag;

FIG. 4 illustrates a cross-sectional view of one example of a zipper assembly shown in FIG. 3; and

FIG. 5 illustrates a flowchart of one example of a method for providing a gusset bag having a tear strip.

### DETAILED DESCRIPTION

Flexible packaging solutions, such as gusset bags, are widely used in various industries for storing and transporting goods. Gusset bags typically include additional panels, referred to as gussets, which are positioned between the front and rear panels or along opposite sides of the bag. These gussets provide increased interior volume, allowing the bags to accommodate larger or bulkier items. Despite their advantages in terms of capacity and flexibility, gusset bags often face challenges related to ease of access and resealability, particularly when used for consumer goods requiring repeated opening and closing.

In existing designs, tear strips have been incorporated into certain types of flexible bags to facilitate opening. These tear strips are typically positioned beneath the front panel of the bag, with a tab or head accessible through an opening in the front panel. Consumers can grasp the tab or head and pull the tear strip to create an opening in the front panel, providing access to the contents of the bag. Once opened, the consumer can access a zipper mechanism located between the front and rear panels, which allows the bag to be resealed after use. However, these designs are generally limited to bags with simple front and rear panel configurations and do not account for the structural complexities introduced by gusset panels.

Known gusset bags often lack tear strips due to the challenges posed by the additional gusset panels. The presence of gussets complicates the integration of tear strips, as creating an opening for the tear strip may require cutting through multiple panels, potentially compromising the structural integrity of the bag. Additionally, the placement of tear strips in gusset bags can be difficult to align with resealable mechanisms, such as zippers, without introducing manufacturing complexities or increasing production costs. As a result, consumers may find gusset bags less convenient to use, particularly when repeated access to the contents is required.

The subject matter described herein addresses these challenges by providing a novel gusset bag design that incorporates a tear strip in a manner that is both functional and compatible with the structural features of gusset bags. The described design includes a gusset bag with a front panel, a rear panel, and first and second gusset panels that extend around an interior volume. The front panel and one of the gusset panels are coupled by a fin seal, and a zipper assembly is positioned along the inside surfaces of the front panel and at least a portion of the gusset panel within the fin seal. The zipper assembly includes interlocking elements that can repeatedly mate and separate to seal and open the interior volume. A tear strip is integrated into the zipper assembly, with a head accessible through an access hole in the front panel. This configuration allows the tear strip to be grasped and pulled to create an opening in the front panel, providing access to the zipper assembly while maintaining the structural integrity of the gusset bag.

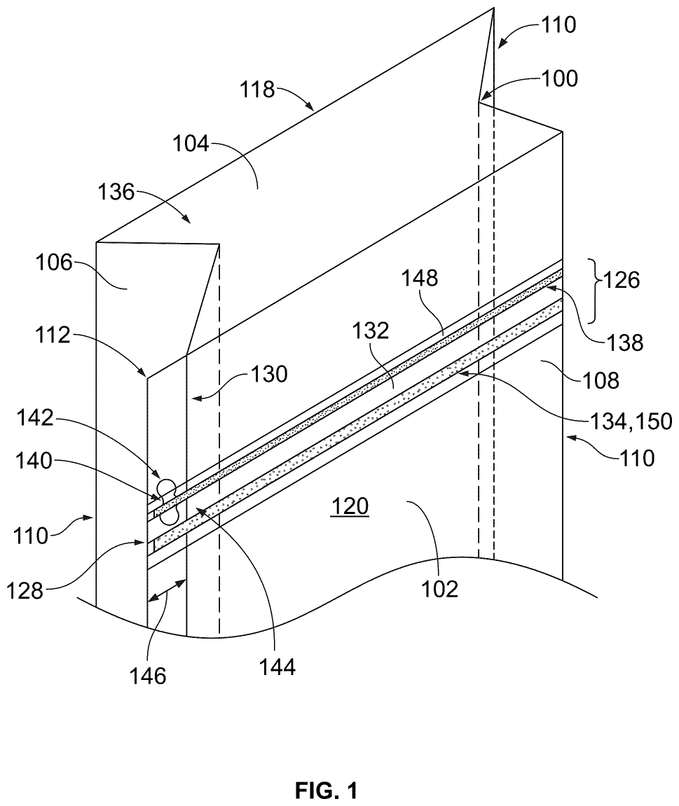

FIG. 1 illustrates one example of a gusset bag 100. The gusset bag 100 can represent a side gusseted bag or package. The gusset bag 100 includes a first (or front) panel 102 and an opposite second (or back) panel 104 connected with each other by opposite first and second side gusset panels 106, 108. In the perspective of FIG. 1, the first and second side gusset panels 106, 108 can be referred to as left and right side gusset panels, respectively. Not all examples, however, are limited to the first side gusset panel 106 being on the left side of the bag 100 and the second side gusset panel 108 being on the right side of the bag 100. Optionally, the first side gusset panel 106 may be on the right side of the bag 100 and the second side gusset panel 108 may be on the left side of the bag 100.

The panels 102, 104, 106, 108 may be different portions of a single web of flexible material, such as one or more polymers described herein. This web may then be folded into a tube with folds 110 formed between the panels 102, 104, between the panels 104, 106, and between the panels 106, 108. The panels 102, 106 may be sealed to each other by a seal 112, such as a corner fin seal or a fold-over seam. This seal 112 can be formed by coupling (e.g., sealing) portions of inside surfaces 136 of the panels 102, 106 to each other, as shown in FIG. 1. For example, the fin seal 112 can be made by placing a width 146 of the front panel 102 against an equivalent or similar (e.g., withing manufacturing tolerances) width 146 of the side panel 106 and sealing these widths 146 together. The widths 146 may extend along the inside surfaces 136 of the panels 102, 106 and may be longer or wider than just the outer edges or thickness of the panels 102, 106.

The bottom of the bag 100 may be formed by sealing the bottom edges of the panels 102, 104, 106, 108 with each other, or by sealing the bottom edges of the panels 102, 104, 106, 108 to a bottom panel (e.g., a bottom gusset panel). Top edges 118 of the panels 102, 104, 106, 108 may be sealed with each other to enclose an interior volume 120 of the gusset bag 100. The seals or couplings between the panels 102, 104, 106, 108, the top edges 118, and/or the bottom edges may be formed using an adhesive and/or heat between the sealed or coupled components. The bottom edges of the panels 102, 104, 106, 108 are not visible but may be similar or identical to the top edges 118 shown in FIG. 1.

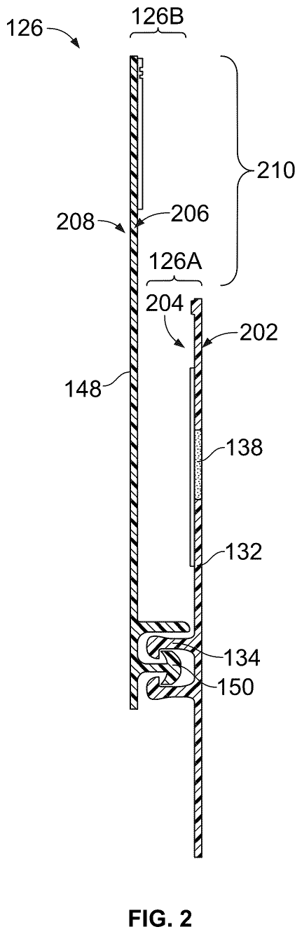

A zipper assembly 126 may be coupled with the inside surface 136 of the front panel 102. The inside surfaces 136 of the panels 102, 104, 106, 108 face each other. With continued reference to the gusset bag 100 shown in FIG. 1, FIG. 2 illustrates a cross-sectional view of one example of the zipper assembly 126. The zipper assembly 126 may be referred to as a multi-part or two part zipper assembly as the zipper assembly 126 includes two zipper assembly parts 126A, 126B that are separately coupled with the same inside surface 136 of the front panel 102 and that alternate between mating with each other (to seal the bag 100 closed) and separating from each other (to open the bag 100).

The part 126A may be referred to as a front part of the zipper assembly 126. The part 126A includes a flange 132 that is a planar or predominantly planar body having a panel side 202 and an opposite locking side 204. The panel side 202 may be adhered to the inside surface 136 of the front panel 102 (e.g., using adhesive and/or heat). The locking side 204 includes one or more interlocking bodies 134 protruding away from the locking side 204 and away from the inside surface 136 of the front panel 102 (and toward the inside surface 136 of the opposing panel 104.

The part 126B may be referred to as a rear part of the zipper assembly 126. The part 126B includes another flange 148 that is a planar or predominantly planar body having a panel and/or locking side 206 and an opposite side 208. The panel side 206 may be adhered to the inside surface 136 of the front panel 102 (e.g., using adhesive and/or heat). For example, a portion 210 of the side 206 of the flange 148 that extends above the flange 132 of the front part 126A may be adhered to the front panel 102. The opposite side 208 of the flange 148 may be adhered to the inside surface 136 of the back panel 104. The panel and/or locking side 206 includes one or more interlocking bodies 150 protruding away from the side 206, toward the inside surface 136 of the front panel 102, and away from the back panel 104.

In the illustrated example, the interlocking bodies 134, 150 are shaped to mate with each other. For example, the interlocking body 150 may have an elongated stem and a bulbous head at a distal end of the stem. The interlocking body 134 may have a female shape that receives the interlocking body 150. Optionally, the interlocking bodies 134, 150 may have another shape. The interlocking bodies 134, 150 are shaped to mate with each other. The parts 126A, 126B of the zipper assembly 126 may be pressed against each other to cause the interlocking bodies 134, 150 to mate with each other and close the interior volume 120 of the bag 100. The parts 126A, 126B of the zipper assembly 126 may then be pulled apart to separate the interlocking bodies 134, 150 from each other. This can open the interior volume 120 of the bag 100. The interlocking bodies 134, 150 may be repeatedly mated and separated from each other to repeatedly seal and unseal the interior volume 120 of the gusset bag 100.

The flange 132 of the front part 126A of the zipper assembly 126 can include an elongated tear strip 138. In the illustrated example, the tear strip 138 is formed as a section or segment of the flange 132. Optionally, the tear strip 138 may be embedded within the flange 132 such that the flange 132 surrounds all four sides of the tear strip 138 shown in FIG. 2. The tear strip 138 can be made from a material that differs from, and is stronger than, the material from which the flange 132 and/or panels 102, 104, 106, 108 are made. For example, the flange 132 and/or panels 102, 104, 106, 108 may be formed from low density polyethylene (LDPE) while the tear strip 138 is formed from high density polyethylene (HDPE), polypropylene (PP), or a cyclic olefin copolymer (COC).

The zipper assembly 126 is not connected with any part of the back panel 104 or the other gusset panel 108 in one example. The zipper assembly 126 extends along the inside surface 136 of the front panel 102. A small portion of the zipper assembly 126 can be coupled with the gusset panel 106 that is connected with the front panel 102 within the fin seal 112 and inside of the outer edge 128. But the zipper assembly 126 may not be coupled, sealed, or affixed to any part of the other gusset panel 108 or the back panel 104.

The tear strip 138 can be pulled and release from the flange 132 either by tearing or peeling. When the flange 132 is covered by the panel 102 of the gusset bag 100, the tear strip 138 can be pulled to tear through the panel 102 and create an opening in the panel 102. This can allow a user or consumer to access the interlocking elements 134, 150 of the zipper assembly 126 to pull and separate the interlocking elements 134, 150 and gain access to the interior volume 120 of the gusset bag 100.

A tab or head 140 of the tear strip 138 may be accessible to a consumer via an access hole or opening 142 in the panel 102. The access hole or opening 142 may be formed or cut by a punch or other tool through at least the panel 102. Optionally, the access hole or opening 142 may be formed through the panel 102 and the side panel 106. The tab or head 140 of the tear strip 138 may be a part of the tear strip 138 that remains and is not cut away when the access hole or opening 142 is formed. The tab or head 140 of the tear strip 138 may include part of the flange 132 of the zipper assembly 126 that remains connected to the tear strip 138 when the access hole or opening 142 is formed. While the tab or head 140 of the tear strip 138 is accessible via the access hole or opening 142, the remainder of the tear strip 138 may be inaccessible from outside the gusset bag 100.

As shown, the zipper assembly 126 may extend from a leading edge that is at the outer edge 128 of the fin seal 112, and across the entire width of the panel 102 without extending across any other panel 104, 108. An end edge 144 of the zipper assembly 126 that is opposite the leading edge may be located short of the fin seal 112. For example, the end edge 144 of the zipper assembly 126 may be located along the inside surface 136 of the panel 106 but not within the fin seal 112 and may be spaced apart from the fin seal 112. The leading edge of the zipper assembly 126 may not be at the same location of the outer edge 128 of the fin seal 112 in another example. For example, the leading edge of the zipper assembly 126 may be located along the inside surface 126 of the panel 102 between the outer edge 128 of the fin seal 112 and the access hole or opening 142.

In operation, the gusset bag 100 may be completely sealed closed but for the access hole or opening 142 that is above the seal created by the mated interlocking bodies 134, 150. A consumer can grasp the tab or head 140 of the tear strip 138 and pull the tab or head 140 away from the fin seal 112 and toward the fold 110 between the panels 102, 110. This can tear an opening through the panel 102 above the interlocking bodies 134, 150 of the tear strip 138. As the tear strip 138 only extends along the panel 102, the opening that is torn by pulling the tear strip 138 may only extend across and through the panel 102. The consumer can reach into this opening and grasp the flanges 132, 148 in different portions of the zipper assembly 126 that oppose each other. For example, the consumer can grasp part of the flange 132 that is adhered to the inside surface 136 of the front panel 102 and part of the flange 148 that is adhered to the inside surface 136 of the panel 104. The consumer can pull these parts of the flanges 132, 148 away from each other to separate the mated interlocking bodies 134, 150 from each other. This can open the interior volume 120 to the consumer via the opening torn by the tear strip 138 and the separated interlocking bodies 134, 150 of the zipper assembly 126.

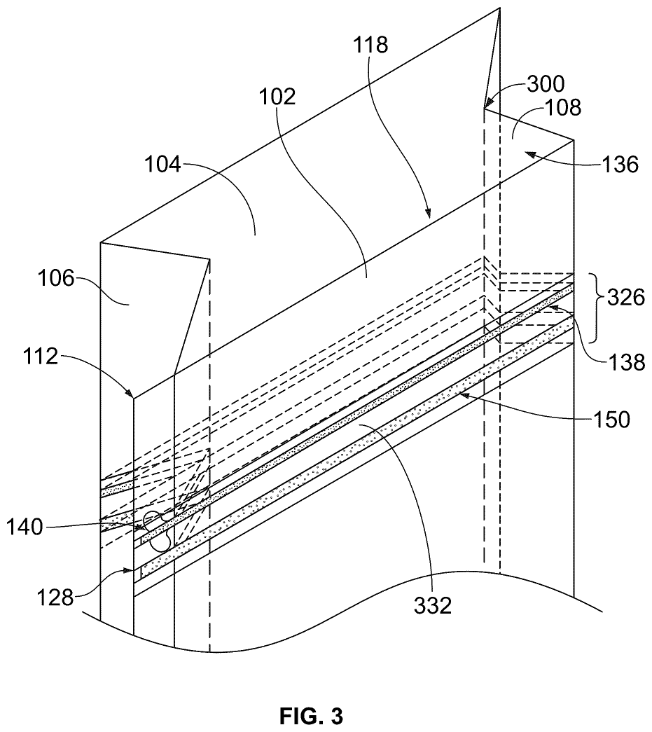

FIG. 3 illustrates another example of a gusset bag 300. The gusset bag 300 can represent a side gusseted bag or package. The gusset bag 300 can include the panels 102, 104, 106, 108 and the seal 112. A zipper assembly 326 may be coupled with the inside surfaces 136 of the panels 102, 104, 106, 108. The zipper assembly 326 can include the flange 132 and the tear strip 138.

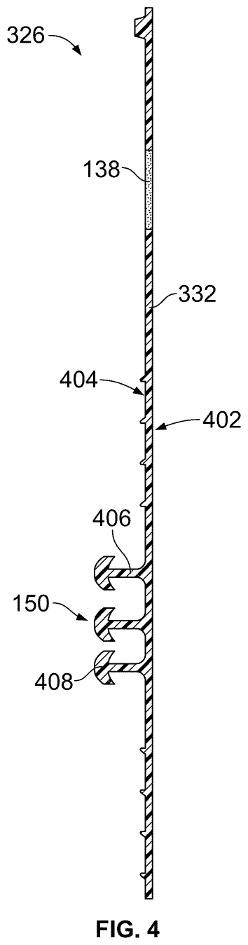

With continued reference to the bag 300 shown in FIG. 3, FIG. 4 illustrates a cross-sectional view of one example of the zipper assembly 326. The zipper assembly 326 includes a flange 332 that is a planar or predominantly planar body having a panel side 402 and an opposite locking side 404. The panel side 402 may be adhered to the inside surfaces of the panels 102, 104, 106, 108 (e.g., using adhesive and/or heat). The locking side 404 includes several of the interlocking bodies 150 protruding away from the locking side 404.

In the illustrated example, the interlocking bodies 150 have elongated stems 406 and bulbous heads 408 at distal ends of the stems 406. Optionally, the interlocking bodies 150 may have another shape. The interlocking bodies 150 are shaped to mate with themselves. Different portions of the length of the zipper assembly 326 (e.g., that extend into and out of the plane of FIG. 2) may be pressed against each other to cause the interlocking bodies 150 in one length portion of the flange 332 to mate with the interlocking bodies 150 in another length portion of the flange 332. For example, the portion of the zipper assembly 326 extending along the inside surfaces 136 of the side panels 106, 108 may mate with different portions of the zipper assembly 326 extending along the inside surfaces 136 of the panels 102, 104.

The heads 408 of the interlocking bodies 150 in one length portion can fit between the heads 408 and stems 406 of the other length portion when pressed together. This can seal the interior volume 120 closed. The different portions of the zipper assembly 326 may then be pulled apart to separate the interlocking bodies 150 from each other. This can open the interior volume 120. The interlocking bodies 150 may be repeatedly mated and separated from each other to repeatedly seal and unseal the interior volume 120 of the gusset bag 100.

The zipper assembly 326 can include the tear strip 138. In the illustrated example, the tear strip 138 is formed as a section or segment of the flange 332. Optionally, the tear strip 138 may be embedded within the flange 332 such that the flange 332 surrounds all four sides of the tear strip 138 shown in FIG. 4. The tear strip 138 can be made from a material that differs from, and is stronger than, the material from which the flange 332 and/or panels 102, 104, 106, 108 are made. For example, the flange 332 and/or panels 102, 104, 106, 108 may be formed from LDPE while the tear strip 138 is formed from HDPE, PP, or a COC.

In contrast to the gusset bag 100 shown in FIG. 1, the entire length of the zipper assembly 326 may include the tear strip 138. For example, the tear strip 138 may extend from the leading edge of the zipper assembly 326 to the end edge of the zipper assembly 326. The tear strip 138 may extend along the widths of the panels 102, 104, 106, 108 such that the tear strip 138 encircles the inside perimeter of the gusset bag 300 above the interlocking bodies 150 of the zipper assembly 326.

The consumer can grasp and pull on the tab or head 140 of the tear strip 326 and pull the tear strip 326 to form an opening through the panel 102, the panel 104, the panel 106, and/or the panel 108 of the gusset bag 300. This can result in the top of the gusset bag 300 that is between the tear strip 326 and the top edges 118 of the panels 102, 104, 106, 108 being torn off of and separated from the remainder of the gusset bag 300. The consumer can then separate the interlocking bodies 150 of the tear strip 326 to access the interior volume 120 of the gusset bag 300.

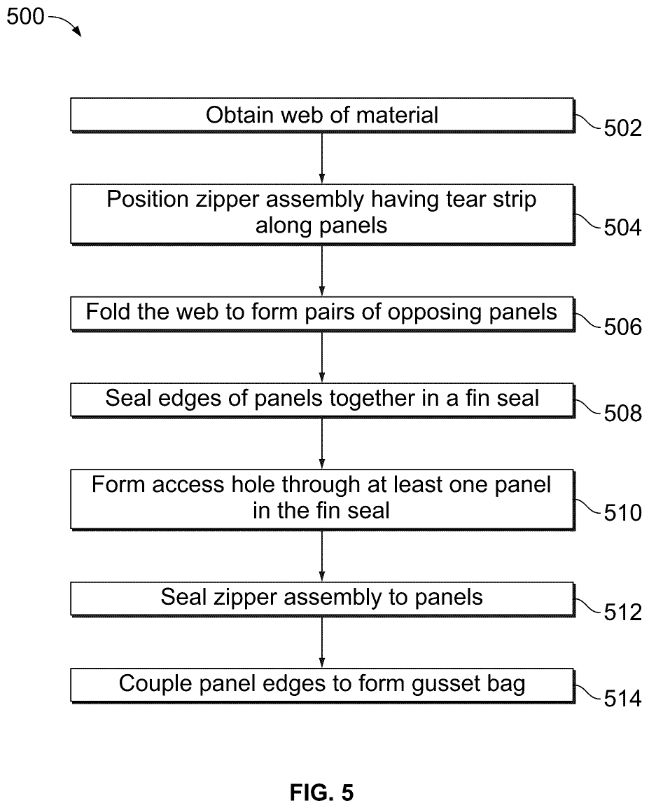

FIG. 5 illustrates a flowchart of one example of a method 500 for providing a gusset bag having a tear strip. The method 500 can represent operations performed to provide the gusset bags 100 and/or 300 described above, or another gusset bag, having the tear strip 138. At 502, a web of material used to form the panels of the gusset bag is obtained.

At 504, a zipper assembly is positioned or placed along inside surfaces of the panels. In one example, the zipper assembly is not yet sealed, adhered, affixed, or otherwise coupled with any of the panels, but is merely placed along the inside surfaces of the panels without being sealed, adhered, affixed, or otherwise coupled with the panels. The zipper assembly may have a tear strip that extends along a portion of the length of the zipper assembly. The tear strip may extend in the zipper assembly along part, but not all, of the length of the zipper assembly. For example, the tear strip may extend along less than half of the length of the zipper assembly.

At 506, this web is folded to form at least a first pair of opposing panels with at least a second pair of opposing panels between the panels in the first pair. The first pair of panels may include the front and rear panels of the gusset bag while the second pair of panels may include right and left side panels of the gusset bag. In this state, the panels may form a tube or annular shape.

At 508, edges of the web are sealed together. The opposite edges of the web that also are edges of the front panel and one of the side panels may be sealed together using heat and/or an adhesive. This seal may be referred to as a fin seal or an edge seal. The fin seal may be formed with the zipper assembly extending into the fin seal. For example, at least one end of the zipper assembly may extend to the edge of the front panel and be sealed between the front panel and the side panel when these panels are sealed together to form the fin seal. The remainder of the zipper assembly may not be sealed to the remaining portions of the panels at this point in the method 500.

At 510, an access hole or opening may be formed through at least the front panel within the fin seal. As described above, this access hole or opening may provide the consumer with access to the tab or head of the tear strip. Optionally, the access hole or opening may be formed through the front panel and the side panel within the fin seal. At 512, the remainder of the zipper assembly may be sealed to the inside surfaces of the panels. For example, the rest of the zipper assembly that is not already sealed to the front and side panels within the fin seal may be sealed to the remainder of the front panel, the other side panel, the rear panel, and the remainder of the side panel that forms part of the fin seal using heat and/or adhesive. In one example, the zipper assembly may be sealed to the panels only after the fin seal is formed and the access hole or opening is formed. This can help ensure that the access hole or opening is aligned with the tear strip. Forming the access hole or opening while the zipper assembly is partially sealed to the panels (e.g., within the fin seal) can ensure that the access hole or opening is aligned with the tear strip (e.g., is over the tear strip to form the head or tab of the tear strip). If the zipper assembly were sealed to the inside of the panels prior to forming the fin seal, the risk of forming the access hole or opening in a location that is not over the tear strip (to form the tab or head of the tear strip) can increase.

At 514, the top edges of the panels may be sealed to each other and/or the bottom edges of the panels may be sealed to each other. The top edges may be directly sealed to each other or another panel (e.g., a top panel) may be placed between and sealed to the top edges of the panel. The bottom edges may be directly sealed to each other or another panel (e.g., a bottom panel) may be placed between and sealed to the bottom edges of the panel.

One example of a gusset bag described herein can include a front panel, a rear panel that is opposite the front panel, a first gusset panel that extends from the front panel to the rear panel, and a second gusset panel that is opposite the first gusset panel and that extends from the front panel to the rear panel. The front panel, the rear panel, the first gusset panel, and the second gusset panel can extend around an interior volume. The front panel and the first gusset panel can be coupled with each other by a fin seal. The gusset bag also can include a zipper assembly coupled with inside surfaces of the front panel and at least a portion of the first gusset panel that is coupled with the front panel by the fin seal. The zipper assembly can include interlocking elements that repeatedly mate and separate from each other to repeatedly seal and open the interior volume. The zipper assembly can include a tear strip having a head that can be grasped and pulled to pull the tear strip through at least the front panel to tear an opening through the front panel to provide access to the zipper assembly. The head of the tear strip can be disposed in the fin seal between the front panel and the first gusset panel.

The tear strip can extend through a length of the zipper assembly that is coupled with the front panel. The zipper assembly can be coupled with and can extend along the front panel, the first gusset panel, the rear panel, and the second gusset panel. Optionally, the tear strip may not extend through any of the zipper assembly that is coupled with the second gusset panel, and the tear strip may not extend through any of the zipper assembly that is coupled with the rear panel.

The tear strip can extend through a length of the zipper assembly that is coupled with each of the front panel, the rear panel, the first gusset panel, and the second gusset panel. The front panel can include an access hole through which the head of the tear strip is accessible. The front panel may include the access hole in a portion of the front panel that is part of the fin seal.

One example of a method (e.g., for providing a gusset bag) described herein can include folding a web of material to form a front panel, a rear panel, a first gusset panel, and a second gusset panel, and placing a zipper assembly having interlocking bodies and a tear strip. The zipper assembly can be placed along the front panel and at least a portion of the first gusset panel. The interlocking bodies can repeatedly mate and separate from each other. The tear strip can have a head configured to be pulled to tear a hole through at least the front panel with the tear strip. The method also can include coupling the front panel with the at least the portion of the first gusset panel in a fin seal with the head of the tear strip positioned within the fin seal, directly or indirectly coupling top edges of the front panel, the rear panel, the first gusset panel, and the second gusset panel with each other, and directly or indirectly coupling bottom edges of the front panel, the rear panel, the first gusset panel, and the second gusset panel with each other to form a gusset bag having a tear strip behind at least the front panel.

The method may include sealing the zipper assembly to the front panel and the at least the portion of the first gusset panel after coupling the front panel with the first gusset panel in the fin seal. The method can include forming an access hole through the front panel within the fin seal to provide access to the head of the tear strip. The method may include sealing the zipper assembly to the front panel and the at least the portion of the first gusset panel after coupling the front panel with the first gusset panel in the fin seal and after forming the access hole.

The zipper assembly can be placed along the front panel, the rear panel, the first gusset panel, and the second gusset panel with the tear strip disposed in a portion of the zipper assembly extending along the front panel and the at least the portion of the first gusset panel. The zipper assembly can be placed along the front panel, the rear panel, the first gusset panel, and the second gusset panel with the tear strip disposed in the portion of the zipper assembly extending along the front panel, the first gusset panel, the rear panel, and the second gusset panel. The zipper assembly can be placed along the front panel and the portion of the first gusset panel that is in the fin seal, but not along the rear panel or the second gusset panel.

Another example of a gusset bag described herein can include a front panel, a rear panel that is opposite the front panel, a first side panel that extends from the front panel to the rear panel, and a second side panel that is opposite the first side panel and that extends from the front panel to the rear panel. The front panel, the rear panel, the first side panel, and the second side panel can extend around an interior volume. The front panel and the first side panel can be coupled with each other by a fin seal with an access hole through at least the front panel. The gusset bag also can include a zipper assembly coupled with inside surfaces of the front panel and a portion of the first side panel that is in the fin seal. The zipper assembly can include interlocking elements that can repeatedly mate and separate from each other to repeatedly seal and open the interior volume. The zipper assembly can include a tear strip having a head disposed in the access hole and that can be grasped and pulled to pull the tear strip through at least the front panel to tear an opening through the front panel to provide access to the zipper assembly.

The tear strip can extend through a portion of the zipper assembly that is coupled with the front panel and the portion of the first side panel that is in the fin seal but not any other portion of the second side panel or the rear panel. The tear strip can extend through the zipper assembly along the inside surfaces of the front panel, the rear panel, the first side panel, and the second side panel. The tear strip can extend from the fin seal to a fold between the front panel and the second side panel. Optionally, the tear strip may not extend beyond the fold between the front panel and the second side panel. This fold can be a first fold, and the tear strip also can extend from the first fold to a second fold between the second side panel and the rear panel, and from the second fold to a third fold between the rear panel and the first side panel.

The singular forms “a,” “an,” and “the” include plural references unless the context clearly dictates otherwise. “Optional” or “optionally” means that the subsequently described event or circumstance may or may not occur, and that the description may include instances where the event occurs and instances where it does not. Approximating language, as used herein throughout the specification and claims, may be applied to modify any quantitative representation that could permissibly vary without resulting in a change in the basic function to which it may be related. Accordingly, a value modified by a term or terms, such as “about,” “substantially,” and “approximately,” may be not to be limited to the precise value specified. In at least some instances, the approximating language may correspond to the precision of an instrument for measuring the value. Here and throughout the specification and claims, range limitations may be combined and/or interchanged, such ranges may be identified and include all the sub-ranges contained therein unless context or language indicates otherwise.

This written description uses examples to disclose the embodiments to enable a person of ordinary skill in the art to practice the embodiments, including making and using any devices or systems and performing any incorporated methods. The claims define the patentable scope of the disclosure, and include other examples that occur to those of ordinary skill in the art. Such other examples are intended to be within the scope of the claims if they have structural elements that do not differ from the literal language of the claims, or if they include equivalent structural elements with insubstantial differences from the literal language of the claims.

What is claimed is:

1. A gusset bag comprising:
a front panel;
a rear panel that is opposite the front panel;
a first gusset panel that extends from the front panel to the rear panel;
a second gusset panel that is opposite the first gusset panel and that extends from the front panel to the rear panel, the front panel, the rear panel, the first gusset panel, and the second gusset panel extending around an interior volume, the front panel and the first gusset panel coupled with each other by a fin seal; and
a zipper assembly coupled with inside surfaces of the front panel and at least a portion of the first gusset panel that is coupled with the front panel by the fin seal, the zipper assembly including interlocking elements configured to repeatedly mate and separate from each other to repeatedly seal and open the interior volume,
the zipper assembly including a tear strip having a head configured to be grasped and pulled to pull the tear strip through at least the front panel to tear an opening through the front panel to provide access to the zipper assembly, the head of the tear strip disposed in the fin seal between the front panel and the first gusset panel.

2. The gusset bag of claim 1, wherein the tear strip extends through a length of the zipper assembly that is coupled with the front panel.

3. The gusset bag of claim 1, wherein the zipper assembly is coupled with and extends along the front panel, the first gusset panel, the rear panel, and the second gusset panel.

4. The gusset bag of claim 3, wherein the tear strip does not extend through any of the zipper assembly that is coupled with the second gusset panel, and the tear strip does not extend through any of the zipper assembly that is coupled with the rear panel.

5. The gusset bag of claim 1, wherein the tear strip extends through a length of the zipper assembly that is coupled with each of the front panel, the rear panel, the first gusset panel, and the second gusset panel.

6. The gusset bag of claim 1, wherein the front panel includes an access hole through which the head of the tear strip is accessible.

7. The gusset bag of claim 6, wherein the front panel include the access hole in a portion of the front panel that is part of the fin seal.

8. A method comprising:
folding a web of material to form a front panel, a rear panel, a first gusset panel, and a second gusset panel;
placing a zipper assembly having interlocking bodies and a tear strip, the zipper assembly placed along the front panel and at least a portion of the first gusset panel, the interlocking bodies configured to repeatedly mate and separate from each other, the tear strip having a head configured to be pulled to tear a hole through at least the front panel with the tear strip;
coupling the front panel with the at least the portion of the first gusset panel in a fin seal with the head of the tear strip positioned within the fin seal;
directly or indirectly coupling top edges of the front panel, the rear panel, the first gusset panel, and the second gusset panel with each other; and
directly or indirectly coupling bottom edges of the front panel, the rear panel, the first gusset panel, and the second gusset panel with each other to form a gusset bag having a tear strip behind at least the front panel.

9. The method of claim 8, further comprising:
sealing the zipper assembly to the front panel and the at least the portion of the first gusset panel after coupling the front panel with the first gusset panel in the fin seal.

10. The method of claim 8, further comprising:
forming an access hole through the front panel within the fin seal to provide access to the head of the tear strip.

11. The method of claim 10, further comprising:
sealing the zipper assembly to the front panel and the at least the portion of the first gusset panel after coupling the front panel with the first gusset panel in the fin seal and after forming the access hole.

12. The method of claim 8, wherein the zipper assembly is placed along the front panel, the rear panel, the first gusset panel, and the second gusset panel with the tear strip disposed in a portion of the zipper assembly extending along the front panel and the at least the portion of the first gusset panel.

13. The method of claim 12, wherein the zipper assembly is placed along the front panel, the rear panel, the first gusset panel, and the second gusset panel with the tear strip disposed in the portion of the zipper assembly extending along the front panel, the first gusset panel, the rear panel, and the second gusset panel.

14. The method of claim 8, wherein the zipper assembly is placed along the front panel and the portion of the first gusset panel that is in the fin seal, but not along the rear panel or the second gusset panel.

15. A gusset bag comprising:
a front panel;
a rear panel that is opposite the front panel;
a first side panel that extends from the front panel to the rear panel;
a second side panel that is opposite the first side panel and that extends from the front panel to the rear panel, the front panel, the rear panel, the first side panel, and the second side panel extending around an interior volume, the front panel and the first side panel coupled with each other by a fin seal with an access hole through at least the front panel; and
a zipper assembly coupled with inside surfaces of the front panel and a portion of the first side panel that is in the fin seal, the zipper assembly including interlocking elements configured to repeatedly mate and separate from each other to repeatedly seal and open the interior volume,
the zipper assembly including a tear strip having a head disposed in the access hole and configured to be grasped and pulled to pull the tear strip through at least the front panel to tear an opening through the front panel to provide access to the zipper assembly.

16. The gusset bag of claim 15, wherein the tear strip extends through a portion of the zipper assembly that is coupled with the front panel and the portion of the first side panel that is in the fin seal but not any other portion of the second side panel or the rear panel.

17. The gusset bag of claim 15, wherein the tear strip extends through the zipper assembly along the inside surfaces of the front panel, the rear panel, the first side panel, and the second side panel.

18. The gusset bag of claim 15, wherein the tear strip extends from the fin seal to a fold between the front panel and the second side panel.

19. The gusset bag of claim 18, wherein the tear strip does not extend beyond the fold between the front panel and the second side panel.

20. The gusset bag of claim 18, wherein the fold is a first fold, and the tear strip also extends from the first fold to a second fold between the second side panel and the rear panel, and from the second fold to a third fold between the rear panel and the first side panel.
